(19) United States
(12) Patent Application Publication
(10) Pub. No.: US 2003/0034597 A1
(43) Pub. Date: Feb. 20, 2003

(54) Shock filtering apparatus

(76) Inventors: Andrew R. Wallach, San Jose, CA (US); Gerrit Van Ommering, San Francisco, CA (US)

Correspondence Address: Joyce Kosinski, Loral Space and Communications, Ltd., Suite 385, 655 Deep Valley Drive, Rolling Hills Estates, CA, 90274, US

(21) Appl. No.: 09/933,443

(22) Filed: Aug. 20, 2001

(51) Int. Cl. F16M 1/00

(52) U.S. Cl. 267/136

(57) ABSTRACT

Passive shock filtering apparatus that filters shock waves experienced by structural systems, such as spacecraft and its structures and components, for example. The shock filtering apparatus reflects energy back to a shock source, and generally reflects a propagating shock wave within the boundary of the apparatus. In general, the apparatus comprises a member disposed adjacent to the shock source that has a plurality of slots disposed therethrough that are configured to reflect energy back to the shock source. The plurality of slots typically comprise a set of partially-overlapping slots formed through the member. The apparatus may further comprise a reinforcing layer of material affixed to the member that has slots that overlay and match the slots the formed through the member. The apparatus may have a cylindrical or rectangular cross section and may include a raised rim disposed around the periphery thereof. The apparatus may comprise two members that are separated from each other and have respective pluralities of slots that partially-overlap each other, and which cooperate to reflect energy back to the shock source.

### BACKGROUND

The present invention relates generally to shock attenuating devices and systems, and more particularly, to apparatus for filtering shock experienced by hardware systems, such as a space vehicle.

Spacecraft typically carry systems and components that are deployed once the spacecraft is in orbit. In order to deploy certain systems and components, prestressed bolts are released either by pyrotechnic devices or split spool devices or other release mechanisms. Shock also occurs in space vehicles due to the vehicle separation from the launch vehicle and from fairing separation. The resulting impact on spacecraft bulkheads and other structures cause shock waves to be propagated towards components on the spacecraft. In many applications, and in particular spacecraft or satellite applications, prior art solutions do not exist with respect to designing shock out of a system.

It is therefore an objective of the present invention to provide for apparatus for filtering shock exerted on a hardware system, such as a space vehicle, for example.

### SUMMARY OF THE INVENTION

The present invention provides for passive shock filtering apparatus that filters shock waves experienced by structural systems, such as spacecraft, for example. The shock filtering apparatus provides for passive devices that reflect energy back to a shock source. The shock filtering apparatus does not attenuate the shock; the shock energy is reflected. The shock filtering apparatus reflects a propagating shock wave within the boundary of the apparatus.

The shock filtering apparatus may be a stand alone device, or may be integrated or as a part of a structure. For example, exemplary integrated shock filtering apparatus may be formed in a honeycomb panel of a spacecraft in the following manner. One or more sets of partially overlapping slots surrounding the shock source or the shock sensitive components are formed in a faceskin of the panel without breaking the structure of the honeycomb core. A reinforcing layer of material (a doubler) having matching slots formed therein may be bonded or otherwise affixed to, or integrally formed with, the panel faceskin to reinforce it. Shock filters installed in honeycomb panel (i.e. sandwich panels) must be installed in both the top and bottom face skins.

The structure of the shock filtering apparatus is formed by the panel faceskin, the slots in the panel faceskin, and each cavity of the honeycomb core in which a slot is located. A shock producing element is attached to the panel faceskin or doubler inside the slot pattern and the shock filtering structure of the present invention acts to reflect the energy produced by the shock source back to the shock source. The slots introduce a discontinuity that reflects the shock wave incident upon it.

A second exemplary embodiment of the shock filtering apparatus comprises a circular member, which may be made of metal, for example, having a flat base and an optional circumferential raised rim. A plurality of holes are disposed through the circumferential raised rim or periphery of the base that permit a shock filter to be secured, such as by means of a plurality of bolts, for example, to a structural component or member, such as a bulkhead of a spacecraft, for example. The shock filtering apparatus may also be bonded to the structural component.

The shock filtering apparatus is thus interposed between the shock source and the structural component. One or more sets of partial-circle concentric slightly overlapping slots are formed through the flat base. The slots are generally concentric and are slightly overlapping or staggered with respect to each other. The slots are sized and configured to terminate shock wave propagation caused by a shock source and reflect it back to the source. This may be done using mathematical evaluation along with experimentation.

A third exemplary embodiment of the shock filtering apparatus comprises a rectangular or square member, which may be made of metal, for example, having a flat base and an optional raised rim around its periphery. A plurality of holes are disposed through the raised rim or periphery of the base that permit a shock filter to be secured, such as by means of a plurality of bolts, for example, to a structural component or member. The shock filtering apparatus may also be bonded to the structural component.

The shock filtering apparatus is thus interposed between the shock source and the structural component. One or more sets of staggered, overlapping slots (which are not necessarily linear or circular) are formed through the flat base that parallel respective sides of the raised rim. The slots are sized to terminate and reflect shock wave propagation caused by a shock source.

A fourth exemplary embodiment of the shock filtering apparatus comprises an upper cylindrical member, which may be made of metal, for example, having a flat base and a circumferential raised rim. One or more sets of part-circle concentric slots are formed through the flat base that are sized and configured to terminate shock wave propagation caused by a shock source. A plurality of holes are disposed through the circumferential raised rim or periphery of the base that permit the cylindrical member to be secured, such as by means of a plurality of bolts to a second (or lower) circular plate. The lower circular plate contains one or more sets of part-circle concentric slots. A J-shaped cylindrical member is secured to the bottom flat plate, such as by means of a plurality of bolts, for example. The “J”shaped member is secured, such as by means of a plurality of bolts, for example, to a structural component or member.

The present shock filtering apparatus thus filters shock in at least two ways. Firstly, a selected one of the shock filtering apparatus may be disposed between a shock source and a structural component to which the shock source is normally attached, such as a body of a satellite, for example. Secondly, a selected one of the shock filtering apparatus may be disposed between a shock sensitive component and a structural component. In general, the second embodiment of the shock filtering apparatus is most appropriate for this application.

Thus, the present shock filtering apparatus is disposed at each location where a shock sensitive or shock producing component is attached to a bulkhead or other structural member. Then the shock sensitive or shock producing component is attached to the shock filtering apparatus.

The shock filtering apparatus incorporates several shock filtering and attenuating aspects in a creative compact manner. These include the slots that cause discontinuities, sharp corners and bolted connections. In addition to theoretical correctness, the shock filtering apparatus has several other attributes. The disclosed embodiments of the shock filtering apparatus are relatively inexpensive to fabricate and install, and eliminate or reduce shock qualification costs for sensitive satellite components for example as well as costly design features to withstand high shock levels

The shock filtering apparatus is designed to be adaptable with respect to shape, size, and configuration. For example a shock filter may be used on spacecraft to reflect shock occurring from launch vehicle separation and from fairing separation. This may be done by installing a pattern of slots in the structural path, between the launch vehicle attachment and sensitive spacecraft components. Additionally the shock filtering apparatus can be combined with a “force redirecting shock attenuator”, (disclosed in U.S. patent application Ser. No. 09/906,901) to create an integrated shock control system.

The present invention thus provides an approach to shock isolation, and can be used in numerous applications. Uses for the present invention include space-vehicle and non-space-vehicle hardware.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates a first exemplary embodiment of shock filtering apparatus in accordance with the principles of the present invention that is integrated into a spacecraft panel;

FIGS. 2 and 3 are top and cross sectional views, respectively of a second exemplary embodiment of the present shock filtering apparatus;

FIG. 3a is a cross sectional side view of an alternative embodiment of the shock filtering apparatus shown in FIGS. 1 and 2;

FIGS. 4-6 are top and cross sectional side views, respectively of a third exemplary embodiment of the present shock filtering apparatus;

FIG. 7 is a bottom view of a top plate of a fourth exemplary embodiment of the present shock filtering apparatus;

FIG. 8 is a top view of a bottom plate assembly of the fourth exemplary embodiment of the shock filtering apparatus; and

FIG. 9 is a cross sectional side view of the fourth exemplary embodiment of the shock filtering apparatus.

### DETAILED DESCRIPTION

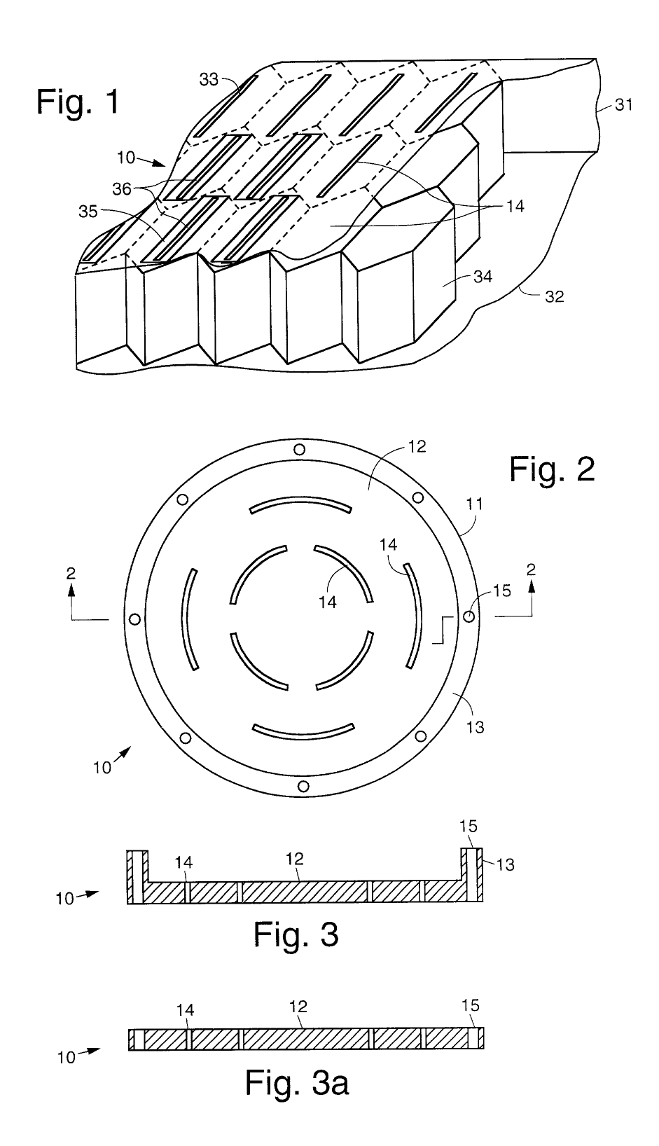

Referring to the drawing figures, FIG. 1 illustrates a first exemplary embodiment of shock filtering apparatus 10 in accordance with the principles of the present invention that is integrated into a honeycomb spacecraft panel 31 of a spacecraft 30 (generally designated). The honeycomb spacecraft panel 31 comprises an outer faceskin 32, an inner faceskin 33, and a honeycomb core 34 sandwiched between the inner and outer faceskins 32, 33.

The integrated shock filtering apparatus 10 comprises one or more sets of partially overlapping slots 14 surrounding a shock source or a shock sensitive component (generally designated) that are disposed or formed in the inner and outer faceskins 33, 32 that provide respective openings to cells of the honeycomb core 34. The partially overlapping slots 34 are formed in the inner and outer faceskins 33, 32 without breaking the structure of the honeycomb core.

Since the integrity of the faceskins 32, 33 are broken by the slots 14, a reinforcing layer 35 (or doubler 35) having a matching slot 36 disposed therein is secured to the surface of the inner and outer faceskins 33, 32, or integrally formed with the inner and outer faceskins 33, 32 to reinforce them. However, it is to be understood that the reinforcing layer 35 may not be required in all circumstances. In general, shock filtering apparatus 10 installed in the honeycomb panel 31 (i.e., sandwich panels) are installed in both the inner and outer (top and bottom) faceskins 33, 32.

The shock source (generally designated) is disposed adjacent to or attached to the inner faceskin 33. The shock source or shock producing element is attached to the panel faceskin or doubler inside the slot pattern. The slots 36, 14 of the shock filtering apparatus 10 operate to reflect energy produced by the shock source back to the shock source. The shock filtering apparatus 10 reflects a propagating shock wave within the boundary of the shock source back to the shock source. The slots 36. 14 introduce a discontinuity that reflects the shock wave incident upon it.

FIGS. 2 and 3 are top and cross sectional side views, respectively of a second exemplary embodiment of the present shock filtering apparatus 10. FIG. 3a is a cross sectional side view of an alternative version of the second embodiment of the shock filtering apparatus 10 shown in FIGS. 2 and 3a.

The second exemplary embodiment of the shock filtering apparatus 10 comprises a circular member 11, which may be made of metal, for example, having a flat base 12 and an optional circumferential raised rim 13. A plurality of holes 15 are disposed through the circumferential raised rim or periphery of the base 13 that permit the shock filtering apparatus 10 to be secured, such as by means of a plurality of bolts, for example, to a structural component or member, such as a bulkhead of a spacecraft 30, for example. The shock filtering apparatus 10 may also be bonded to the structural component. The shock filtering apparatus 10 is thus interposed between the shock source and the structural component.

One or more sets of partial-circle concentric slightly overlapping slots 14 are formed through the flat base 12. The slots 14 are generally concentric and are slightly overlapping or staggered or offset with respect to each other. However, it is to be understood that the overlapping slots 14 need not necessarily be formed as sections of concentric circles. The slots 14 are sized and configured to terminate shock wave propagation caused by the shock source and reflect it back to the shock source. Determination of the structure and configuration of the slots 14 may be done using mathematical evaluation along with a minimal amount of experimentation to determine the appropriate amount of reflection.

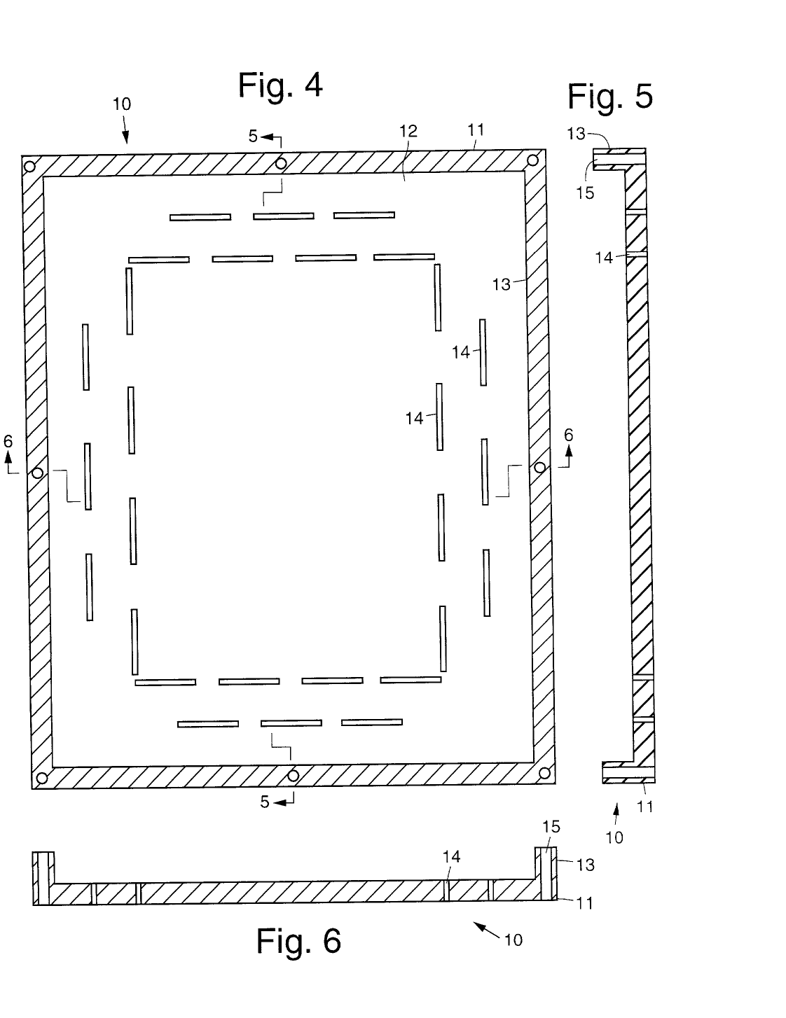

FIGS. 4-6 are top and cross sectional side views, respectively of a third exemplary embodiment of the present shock filtering apparatus 10. FIG. 5 is a cross section view taken along the lines 5-5 of FIG. 4. FIG. 6 is a cross sectional view taken along the lines 6-6 of FIG. 4.

The third exemplary embodiment of the shock filtering apparatus 10 comprises a rectangular or square member 11, which may be made of metal, for example, having a flat base 12 and an optional raised rim 13 around its periphery. A plurality of holes 15 are disposed through the raised rim 13 or periphery of the base 12 that permit the shock filtering apparatus 10 to be secured, such as by means of a plurality of bolts, for example, to a structural component or member. The shock filtering apparatus 10 may also be bonded to the structural component.

The shock filtering apparatus 10 is thus interposed between the shock source and the structural component. One or more sets of staggered, overlapping slots 14 (which are not necessarily linear) are formed through the flat base 12 that may parallel respective sides of the raised rim 13 or periphery of the base 12. The slots 14 are sized and configured to terminate and reflect shock wave propagation caused by a shock source.

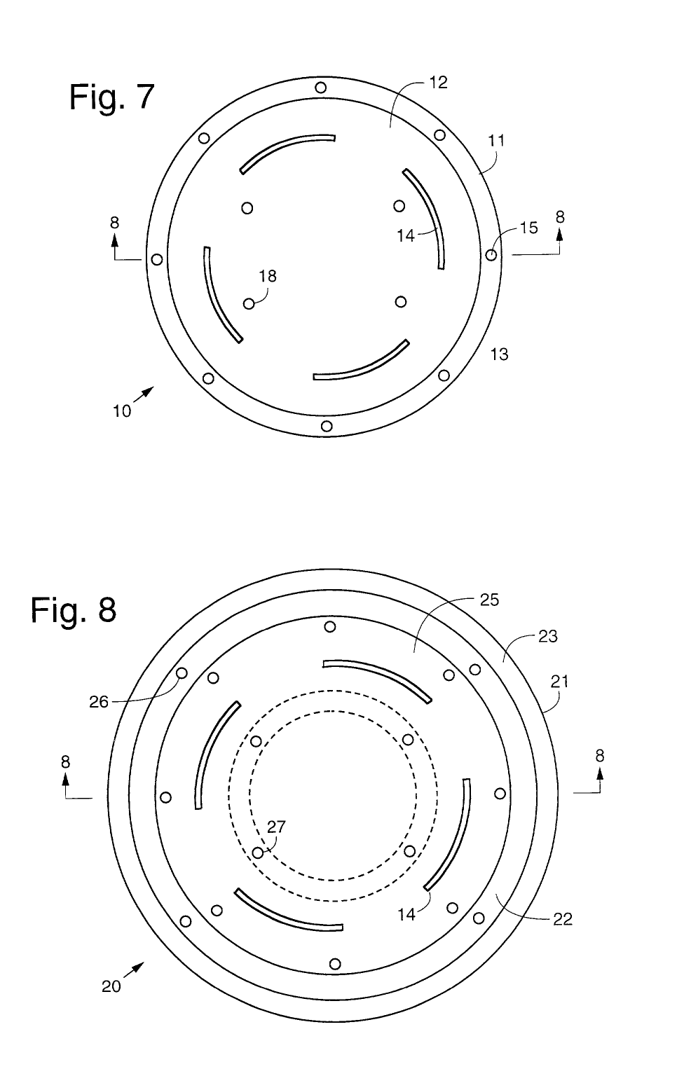

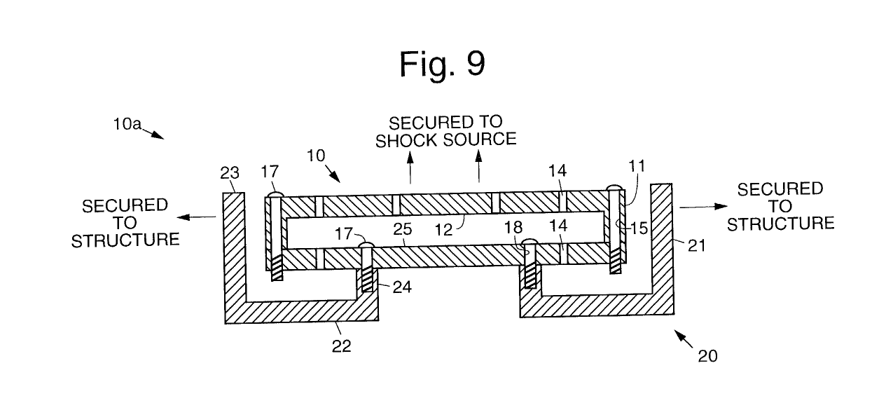

FIGS. 7-9 illustrate a fourth exemplary embodiment of the present shock filtering apparatus 10. FIG. 7 is a bottom view of a top plate of the fourth exemplary embodiment of the shock filtering apparatus 10. FIG. 8 is a top view of a bottom plate assembly of the fourth exemplary embodiment of the shock filtering apparatus 10. FIG. 9 is a cross sectional side view of the fourth exemplary embodiment of the shock filtering apparatus 10, respectively, taken along the lines 8-8 shown in FIGS. 7 and 8.

The fourth exemplary embodiment of the shock filtering apparatus 10 comprises an upper circular member 11 and a lower circular member 20. The upper and lower circular members 11, 20 may be made of metal, for example. The upper circular member 11 has a flat base 12 and a circumferential raised rim 13. One or more sets of part-circle concentric slots 14 are formed through the flat base 12 that are sized and configured to terminate and reflect shock wave propagation caused by a shock source.

A plurality of holes 15 are disposed through the circumferential raised rim 13 that permit the upper circular member 11 to be secured, such as by means of a plurality of bolts 17 (FIG. 9), for example, to a second (or lower) circular plate 25. The lower circular plate 25 also contains one or more sets of partial-circle slots 14. The plurality of partial-circle slots 14 formed through the lower circular plate 25 are generally concentric to and slightly overlap the partial-circle concentric slots 14 formed through the flat base 12 of the upper circular member 11.

A plurality of holes 18 are disposed through the flat base 25 that permit the lower circular member 25 to be secured, such as by means of a plurality of bolts 17, for example, to the lower circular member 20. The lower circular member 20 comprises a J-shaped circular member 20 having an outer rim 21, an inner raised rim 24 and a flat circular plate 22 interconnecting the outer rim 21 to the inner raised rim 24.

The inner raised rim 24 is secured to the second (or lower) circular plate 25 by means of the plurality of the bolts 17. An outer rim 21 of the J-shaped cylindrical member 20 is secured, such as by means of a plurality of bolts (not shown). for example to a structural component or member.

The present shock filtering apparatus 10 filters shock in two ways. A selected one of the shock filtering apparatus 10 may be disposed between a shock source and a structural component to which the shock source is normally attached, such as a body of a satellite, for example. In general, the third and fourth embodiments of the shock filtering apparatus 10 are most appropriate for this application. Also, a selected one of the shock filtering apparatus 10 may be disposed between a shock sensitive component and a structural component. In general, the second embodiment of the shock filtering apparatus 10 is most appropriate for this application.

Thus, the present shock filtering apparatus 10 is disposed at each location where a shock sensitive or shock producing component is attached to a bulkhead or other structural member. Then the shock sensitive or shock producing component is attached to the shock filtering apparatus 10.

The shock filtering apparatus 10 incorporates several shock filtering and attenuating aspects in a creative compact manner. These include the slots that cause discontinuities, sharp corners and bolted connections. In addition to theoretical correctness, the present shock filtering apparatus 10 has several other attributes. The embodiments of the shock filtering apparatus 10 are relatively inexpensive to fabricate and install, and eliminate or reduce shock qualification costs for sensitive satellite components, as well as costly design features to withstand high shock levels, for example.

The shock filtering apparatus 10 is designed to be adaptable with respect to shape, size, and configuration. For example the shock filtering apparatus 10 may be used on spacecraft to reflect shock occurring from launch vehicle separation and from fairing separation. This may be done by installing a pattern of slots in the structural path between the launch vehicle attachment and sensitive spacecraft components. Also, the shock filtering apparatus 10 may be combined with a force redirecting shock attenuator, such as is disclosed in U.S. patent application Ser. No. 09/906,901, assigned to the assignee of the present invention, to create an integrated shock control system.

The present invention provides an approach to shock isolation, and can be used in numerous applications. Uses for the present invention include space-vehicle and non-space-vehicle hardware.

The present invention thus provides for passive shock filtering apparatus 10 that filters shock waves experienced by structural systems, such as spacecraft 30, for example. The shock filtering apparatus 10 may be a standalone device, or may be integrated or built into a wall of a structure, for example. The shock filtering apparatus 10 provides for passive devices that reflect energy back to the shock source. The shock filtering apparatus 10 does not attenuate the shock; the shock energy is reflected.

In operation, and by way of example, the second embodiment of the shock filtering apparatus 10 shown in FIGS. 2, 3 and 3a may be bolted over a cutout in satellite bulkhead. The slots introduce a discontinuity that reflects a shock wave incident thereupon. The optional raised rim 13 causes sharp corner further attenuating the shock wave. The slots and structure of the shock filtering apparatus 10 are engineered such that the strength of filtering apparatus 10 is sufficient.

The third embodiment of the shock filtering apparatus 10 shown in FIGS. 4-6 has the same attributes the second embodiment of the filtering apparatus 10 shown in FIGS. 1-3. The third embodiment is ideal for use under a bracket housing a pyrotechnically-actuated bolt cutter, for example. Dimensions of the shock filtering apparatus 10 are such that a zone between the bracket and slots is sufficient to insure “plate behavior”. This insures that the shock wave is propagated, allowing the filtering apparatus 10 to perform as designed.

The fourth embodiment of the shock filtering apparatus 10 shown in FIGS. 7-9 is similar to the second and third embodiments except for its “stacked” configuration, which causes multiple attenuation modes.

Thus, improved apparatus for filtering shock exerted on a hardware system, such as a space vehicle, for example, have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. Shock filtering apparatus for filtering shock produced by a shock source, comprising:
a member disposed adjacent to the shock source that has a plurality of slots disposed therethrough that are configured to reflect energy back to the shock source.

2. The apparatus recited in claim 1 which reflects a propagating shock wave produced by the shock source within the boundary of the shock source.

3. The apparatus recited in claim 1 wherein the plurality of slots comprise a set of partially overlapping slots formed through the member.

4. The apparatus recited in claim 1 wherein the plurality of slots comprise one or more sets of partially overlapping slots formed through the member.

5. The apparatus recited in claim 1 further comprising a reinforcing layer of material affixed to the member that has slots that partially overlay and match the plurality of slots the formed through the member.

6. The apparatus recited in claim 1 wherein the member has a circular cross section and is disposed between the shock source and a structural member.

7. The apparatus recited in claim 6 wherein the member comprises a plurality of partial-circle concentric partially-ovelapping slots.

8. The apparatus recited in claim 6 wherein the member further comprises a circumferential raised rim disposed around the periphery thereof.

9. The apparatus recited in claim 1 wherein the member has a rectangular cross section and is disposed between the shock source and a structural member that is to be filtered from shock.

10. The apparatus recited in claim 9 wherein the member further comprises a plurality of sets of partially-ovelapping slots.

11. The apparatus recited in claim 9 wherein the member further comprises a raised rim disposed around the periphery thereof.

12. The apparatus recited in claim 9 wherein the member is coupled to a second member that has a second plurality of slots that partially overlap the plurality of slots in the member, and which cooperate with the plurality of slots to reflect energy back to the shock source.

13. The apparatus recited in claim 1 wherein the member is comprises a structural member that is to be filtered from shock.

14. The apparatus recited in claim 1 wherein the member is interposed between the shock source and a structural member that is to be filtered from shock.

15. The apparatus recited in claim 1 wherein the member is coupled to the shock source and the second member is coupled to a structural member that is to be filtered from shock.
